(19) United States
(12) Patent Application Publication
(10) Pub. No.: US 2014/0028121 A1
(43) Pub. Date: Jan. 30, 2014

(54) handheld power tool

(71) Applicants: Miro BEKAVAC, Korntal-Muenchingen (DE); Sebastian Laber, Leinfelden-Echterdingen (DE); Patrick Budaker, Heubach (DE)

(72) Inventors: Miro BEKAVAC, Korntal-Muenchingen (DE); Sebastian Laber, Leinfelden-Echterdingen (DE); Patrick Budaker, Heubach (DE)

(73) Assignee: Robert Bosch GmbH, Stuttgart (DE)

(21) Appl. No.: 13/950,965

(22) Filed: Jul. 25, 2013

(30) Foreign Application Priority Data
Jul. 25, 2012 (DE) 102012213051.9

(51) Int. Cl. H02K 1/27

(52) U.S. Cl. CPC H02K 1/27
USPC 310/50

(57) ABSTRACT

In a handheld power tool having an electronically commutated drive motor, which has a stator provided with a motor winding and a rotor provided with a permanent magnet, the permanent magnet has an axial extension which is configured to enable a detection of a particular rotational position of the rotor.

### RELATED APPLICATION INFORMATION

The present application claims priority to and the benefit of German patent application no. 10 2012 213 051.9, which was filed in Germany on Jul. 25, 2012, the disclosure of which is incorporated herein by reference.

### FIELD OF THE INVENTION

The present invention relates to a handheld power tool having an electronically commutated drive motor which has a stator provided with a motor winding and a rotor provided with a permanent magnet.

### BACKGROUND INFORMATION

Handheld power tools are known from the related art which have electronically commutated drive motors having a stator provided with a motor winding and a rotor provided with a permanent magnet and a rotor shaft, the motor winding and the permanent magnet interacting with one another when the rotor shaft is rotatably driven. To detect a particular rotational position and/or rotational speed of the rotor, a sensor system, which includes a position sensor magnet rotatably fixedly situated on the rotor shaft and Hall sensors which are configured to detect and evaluate the magnetic field of the position sensor magnet, are provided in such drive motors, in the following also referred to as EC motors.

The disadvantage of the related art is that such a sensor system is complex, which results in an increased effort during manufacture and assembly of an EC motor and thus of a corresponding handheld power tool and therefore reduces the economy of the EC motor or the handheld power tool.

### SUMMARY OF THE INVENTION

It is therefore the object of the present invention to provide a novel handheld power tool having an electronically commutated drive motor which is more economical in its manufacture and maintenance, and which may be assembled faster and easier.

This object is achieved by a handheld power tool having an electronically commutated drive motor which has a stator provided with a motor winding and a rotor provided with a permanent magnet. The permanent magnet has an axial extension which is configured to enable a detection of a particular rotational position of the rotor.

The present invention thus makes possible the provision of a handheld power tool having an electronically commutated drive motor in which the provision of a separate additional position sensor magnet may be omitted, so that the drive motor may be manufactured using fewer individual parts and is thus more economical and reliable.

According to one specific embodiment, the motor winding is situated on a stator core provided with a plurality of stator teeth, the permanent magnet having an axial length which is greater by the axial extension than an axial length assigned to the stator teeth.

In this way, the axial extension may be moved in an easy manner out of reach of a magnetic drive field generated by the motor winding of the stator during operation of the drive motor, so that an axially oriented magnetization which is formed by the axial extension may be detected in a largely interference-free manner, for example, by a Hall sensor for detecting the position of the rotor in relation to the stator.

In the area of the stator teeth, the permanent magnet may have a radially oriented magnetization and in the area of the axial extension it has an axially oriented magnetization.

In this way, interfering influences of a magnetic drive field which is provided by the permanent magnet and which is based on the radially oriented magnetization may be prevented safely and reliably in the case of a rotational position detection of a particular rotational position of the rotor by using the axially oriented magnetization.

According to one specific embodiment, the axial extension is assigned at least one sensor element for detecting the axially oriented magnetization of the axial extension.

In this way, the axially oriented magnetization of the axial extension may be detected with the aid of an uncomplicated and cost-effective component.

The sensor element may be situated in the area of the axially oriented magnetization of the axial extension.

Thus, a stable and robust detection of the axially oriented magnetization of the axial extension may be ensured.

The rotor may have a rotor core.

In this way, a simple and fail-safe rotor may be provided.

According to one specific embodiment, the permanent magnet is situated radially on the rotor core, and the rotor core has an axial length which corresponds to an axial length assigned to the stator teeth.

The present invention thus makes possible the provision of a material-saving and thus cost-effective rotor core.

According to one specific embodiment, the permanent magnet is situated radially on the rotor core, and the rotor core has an axial length which corresponds to an axial length assigned to the permanent magnet.

Thus, the magnetic field lines of the axially oriented magnetization of the axial extension are reinforced by the rotor core, so that their detection by the sensor element may be improved.

Moreover, to achieve the object, an electronically commutated drive motor may be used which has a stator provided with a motor winding and a rotor provided with a permanent magnet. The permanent magnet has an axial extension which is configured to enable a detection of a particular rotational position of the rotor.

This drive motor may be expanded to include properties of the drive motor which is situated in the indicated handheld power tool according to the subclaims.

Furthermore, to achieve the object, a method for magnetizing a permanent magnet for an electrically commutated drive motor may be used which has a stator provided with a motor winding and a rotor provided with a permanent magnet, the permanent magnet being configured to enable a detection of a particular rotational position of the rotor. The indicated method includes situating a soft magnetic metal core, provided with at least one electrical conductor, on the permanent magnet, the at least one electrical conductor forming, on a lateral surface of the permanent magnet, printed conductors which are in pairs at least approximately axis-parallel and which extend at least from a first axial end of the permanent magnet to a second axial end of the permanent magnet at which the printed conductors are interconnected in a loop-like manner, the printed conductors extending beyond the second axial end; and a pulsed energization of the electrical conductor at the first axial end of the permanent magnet in order to an axially oriented magnetization at least in the area of the second axial end of the permanent magnet.

The present invention is elucidated in greater detail in the following description with reference to the exemplary embodiments illustrated in the drawings.

### BRIEF DESCRIPTION OF THE DRAWINGS

FIG. 1 shows a schematic view of a handheld power tool having an electronically commutated drive motor according to one specific embodiment.

FIG. 2 shows a simplified longitudinal section through the drive motor from FIG. 1 provided with a permanent magnet.

FIG. 3 shows a perspective view of a configuration for magnetization of the permanent magnet from FIG. 2.

### DETAILED DESCRIPTION

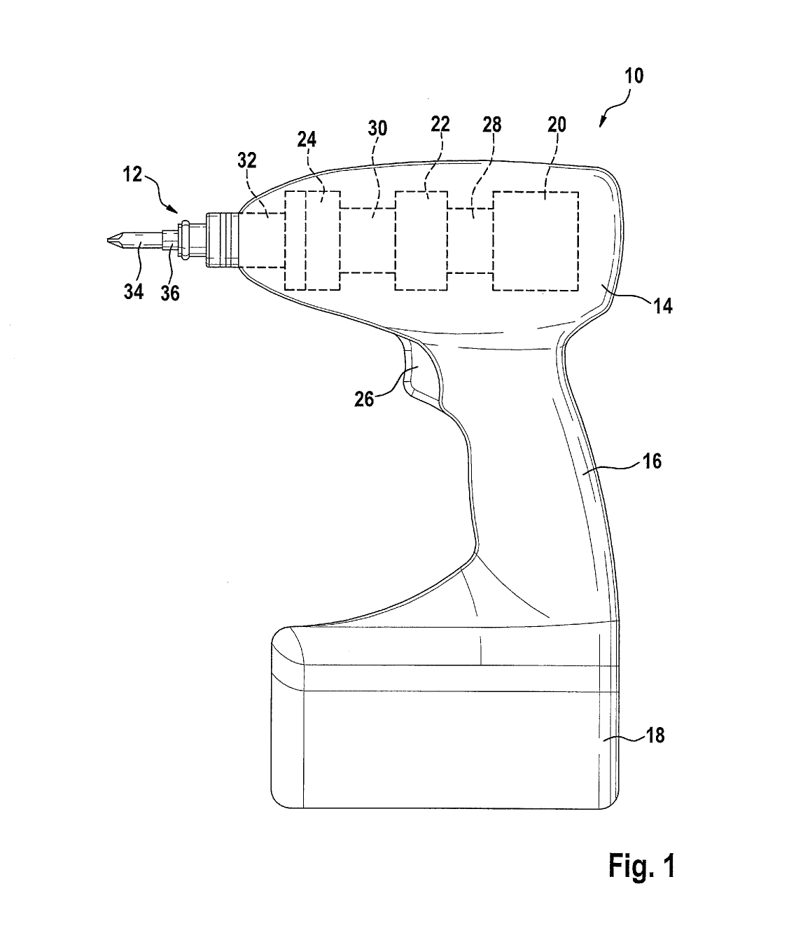

FIG. 1 shows an exemplary handheld power tool 10 having an electronically commutated drive motor 20 according to one specific embodiment. Handheld power tool 10 illustratively has a tool housing 14 having a handle 16 as well as a tool receptacle 12 and is, as an example, connectable mechanically for mains-independent power supply and electrically to a battery pack 18.

Handheld power tool 10 is configured here as a cordless combi drill, as an example. It is, however, pointed out that the present invention is not limited to cordless combi drills, but may rather be used in different power tools in which drive motor 20 may be used, e.g., in a percussion drill, a screwdriver, a cordless drill, an impact drill, a saw, a milling machine, a grinding machine, a garden tool, etc., regardless of whether the power tool is operable cordlessly using battery pack 18, or whether the power tool is mains-operable.

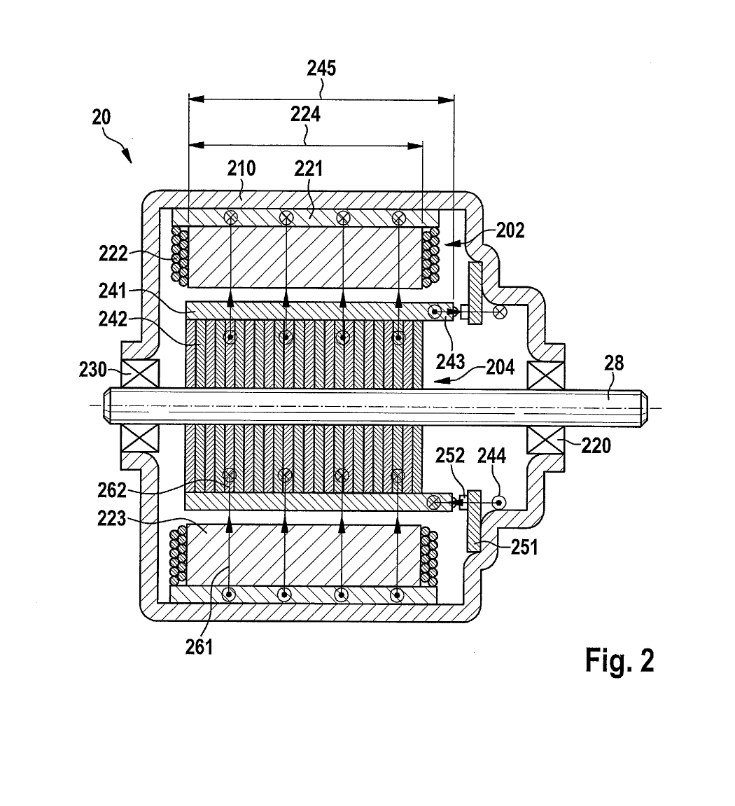

A drive motor 20, which is supplied with power by battery pack 18, a gear 22, and percussion mechanism 24 are situated in tool housing 14, as an example. Drive motor 20 is configured according to one specific embodiment in the form of an EC motor, in particular of a small or very small power motor, and is operable, i.e., may be switched on and off, via a manual switch 26. Drive motor 20 may be controlled or regulated electronically in such a way that a reverse operation and input with regard to a desired rotational speed and/or a torque are implementable. The mode of operation and an exemplary configuration of drive motor 20 are further described below for FIG. 2.

Drive motor 20 is illustratively connected via an associated motor shaft 28 to gear 22 which converts a rotation of motor shaft 28 into a rotation of a drive element 30, e.g. , a drive shaft, provided between gear 22 and percussion mechanism 24. This conversion may take place in such a way that drive element 30 rotates in relation to motor shaft 28 at an increased torque but at a reduced rotational speed. Drive motor 20 and gear 22 are, for example, situated in tool housing 14 according to the so-called open-frame design, but they may alternatively also be situated in separate motor and gear housings according to the so-called can design which, in turn, may be situated in tool housing 14, etc.

Percussion mechanism 24, which is connected to drive element 30, is a rotary percussion mechanism, for example, which generates percussive angular momentums with high intensity and transfers them to an output shaft 32, e.g. , an output spindle. On drive shaft 32, tool receptacle 12 is provided which may be configured for receiving insert tools and is connectable according to one specific embodiment to both an insert tool having an external coupling, e.g., a screwdriver bit, and to an insert tool having an internal coupling, e.g., a socket wrench. Tool receptacle 12 is illustratively connectable to an insert tool 34 having an external polygonal coupling 36 or to an insert tool having an internal polygonal coupling. Insert tool 34 is configured, as an example, as a screwdriver bit having external polygonal coupling 36 which is illustratively configured as a hexagonal coupling and which is situated in tool receptacle 12. Such a screwdriver bit is sufficiently known from the related art so that a detailed description thereof is dispensed with for the sake of a concise description.

FIG. 2 shows drive motor 20 from FIG. 1 provided with a motor shaft 28. The drive motor moreover illustratively has a stator 202 in which a rotor 204, which is rotatably fixedly connected to motor shaft 28, is rotatably mounted, motor shaft 28 forming a rotor shaft which is assigned to rotor 204.

According to one specific embodiment, a rotor core 242, which is configured as a metal sheet package, for example, is rotatably fixedly held on motor or rotor shaft 28. This means that rotor core 242 is formed from a stack of stamped circular metal sheets which are not referred to in greater detail and which are stacked in the axial direction of motor shaft 28 and held thereon. An illustratively hollow-cylindrical permanent magnet 241 which at least sectionally has a radially oriented magnetization 262 and which may be configured in the form of a ring magnet is situated radially on rotor core 242.

Rotor 204 and stator 202 are situated in a housing 210, assigned to drive motor 20, which may be formed by tool housing 14 from FIG. 1 as described in FIG. 1 and on which a first pivot bearing 220 and a second pivot bearing 230 are illustratively fixed for a rotatable mounting of motor or rotor shaft 28. Pivot bearings 220, 230 may, for example, be configured as rolling bearings in a manner known to those skilled in the art. A stator core 221, starting from which stator teeth 223 protrude radially inward, is furthermore fixed in housing 210. In the sectional illustration of FIG. 2, only two of these stator teeth 223 are visible.

A motor winding 222 of drive motor 20 is provided, as an example, on stator teeth 223. By energizing this motor winding 222 during operation of handheld power tool 10 from FIG. 1, a magnetic drive field 261 is formed using which rotor 204 may be driven. Here, magnetic drive field 261 cooperates with radially oriented magnetization 262 of permanent magnet 241 in such a way that stator 202 applies a torque to rotor 204 so that rotor 204 rotates relative to stator 202.

According to one specific embodiment, at least one sensor element 252, which is situated on a sensor PC board 251 fastened in housing 210, for example, is provided for detecting a particular rotational position of rotor 204. Sensor element 252 has, for example, at least one and usually three Hall sensors and is used to detect a sensor magnetic field which is emitted in the present configuration by permanent magnet 241. For this purpose, permanent magnet 241 has an axial extension 243 which is provided with an axially oriented magnetization 244 for generating the sensor magnetic field, which will be elucidated in greater detail below. On the basis of this sensor magnetic field, sensor element 252, for example, generates in a manner known to those skilled in the art a voltage signal and transmits this signal to an evaluation circuit which deduces from the voltage signal the particular rotational position of rotor 204 for further energization of motor winding 222 and thus for generation of magnetic drive field 261.

Axial extension 243 is configured as an example, in that an axial length 245 of permanent magnet 241 is greater than an axial length 224 of stator teeth 223, stator teeth 223 and permanent magnet 241 being situated approximately axially flush on their axial end sides on their sides facing away from sensor element 252. In this case, rotor core 242 has, as an example, an axial length which is identical to axial length 224 of stator teeth 223 in the present embodiment. This is, however, an example, for rotor core 242 may have any desired axial length which is in the range between axial length 224 of stator teeth 223 and axial length 245 of permanent magnet 241.

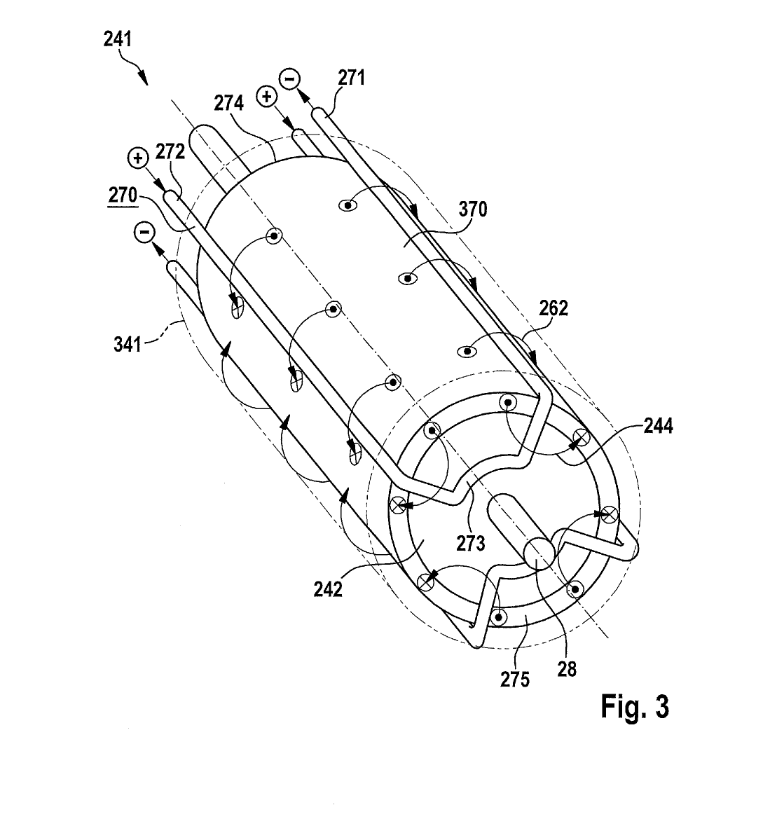

FIG. 3 shows an exemplary method for magnetizing permanent magnet 241 of drive motor 20 from FIG. 2. In a first step, a soft magnetic metal core 341, which is provided with at least one electrical conductor 270, is situated on permanent magnet 241. The at least one electrical conductor 270 forms in pairs at least approximately axis-parallel printed conductors 271, 272 on a lateral surface 370 of permanent magnet 241. These printed conductors extend at least from a first axial end 274 of permanent magnet 241 to a second axial end 275 of permanent magnet 241 on which printed conductors 271, 272 are interconnected in a loop-like manner 273, printed conductors 271, 272 extending beyond second axial end 275.

In a second step, electrical conductor 270 is energized in a pulsed manner at first axial end 274 of permanent magnet 241 to generate the axially oriented magnetization or sensor magnetic field 244 at least in the area of second axial end 275 of permanent magnet 241. Here, radially oriented magnetization 262 is generated which is used to drive rotor 204 from FIG. 2.

It is, however, pointed out that the energization may be arbitrary as long as it remains unipolar. The energization may therefore be a time-constant or a time-variable direct current. Particularly, the energization, however, may take place as described above using current pulses, since it is possible in this case to achieve the greatest possible magnetization with the aid of minimum power usage.

To simplify this method, illustratively hollow-cylindrical or tubular permanent magnet 241 is formed from a ferromagnetic material which may be magnetized and thus magnetically saturated in a simple manner. For this purpose, materials such as soft irons, steels having a low carbon content, steels containing a silicon additive, nickel iron alloys, cobalt iron alloys, or ferrites are suitable. Alternatively, the starting material of permanent magnet 241 may also be a hard magnetic material. In this case, in the presence of a strong magnetic field, for example, permanent magnet 241 would be pressed into its hollow-cylindrical or tubular shape and sintered at a high temperature. The strong magnetic field orients the hard magnetic material so that radial and axial magnetization 262 and 244, respectively, are formed which, however, may initially get lost during sintering and be subsequently reactivated with the aid of the above-described method.

What is claimed is:

1. A handheld power tool, comprising:
an electronically commutated drive motor, which has a stator provided with a motor winding and a rotor provided with a permanent magnet;
wherein the permanent magnet has an axial extension to enable a detection of a particular rotational position of the rotor.

2. The handheld power tool of claim 1, wherein the motor winding is situated on a stator core provided with a plurality of stator teeth, the permanent magnet having an axial length which is greater by the axial extension than an axial length assigned to the stator teeth.

3. The handheld power tool of claim 1, wherein in the area of the stator teeth, the permanent magnet has a radially oriented magnetization and in the area of the axial extension it has an axially oriented magnetization.

4. The handheld power tool of claim 3, wherein the axial extension is assigned at least one sensor element for detecting the axially oriented magnetization of the axial extension.

5. The handheld power tool of claim 4, wherein the sensor element is situated in the area of the axially oriented magnetization of the axial extension.

6. The handheld power tool of claim 1, wherein the rotor has a rotor core.

7. The handheld power tool of claim 6, wherein the permanent magnet is situated radially on the rotor core, and the rotor core has an axial length which corresponds to an axial length assigned to the stator teeth.

8. The handheld power tool of claim 6, wherein the permanent magnet is situated radially on the rotor core, and the rotor core has an axial length which corresponds to an axial length assigned to the permanent magnet.

9. An electronically commutated drive motor, comprising:
a stator provided with a motor winding; and
a rotor provided with a permanent magnet;
wherein the permanent magnet has an axial extension configured to enable a detection of a particular rotational position of the rotor.

10. A method for magnetizing a permanent magnet for an electronically commutated drive motor, which has a stator provided with a motor winding and a rotor provided with a permanent magnet, the method comprising:
situating a soft magnetic metal core, provided with at least one electrical conductor, on the permanent magnet, the at least one electrical conductor forming, on a lateral surface of the permanent magnet, printed conductors which are in pairs at least approximately axis-parallel and which extend at least from a first axial end of the permanent magnet to a second axial end of the permanent magnet at which the printed conductors are interconnected in a loop-like manner, the printed conductors extending beyond the second axial end; and
generating, by a pulsed energization of the electrical conductor at the first axial end of the permanent magnet, an axially oriented magnetization at least in the area of the second axial end of the permanent magnet;
wherein the permanent magnet is configured to enable a detection of a particular rotational position of the rotor
